(19) United States
(12) Patent Application Publication
(10) Pub. No.: US 2006/0169030 A1
(43) Pub. Date: Aug. 3, 2006

(54) In-process mass spectrometry with sample multiplexing

(76) Inventors: Larry N. Stewart, San Jose, CA (US); James E. Garvey, San Jose, CA (US); Jimmy K. Dzuong, San Jose, CA (US); Bijan N. Ghaderi, San Mateo, CA (US); Christopher A. Janko, Redwood City, CA (US)

Correspondence Address: Jon W. Hallman;MacPHERSON KWOK CHEN & HEID LLP, Suite 226, 1762 Technology Drive, San Jose, CA, 95110, US

(21) Appl. No.: 11/298,738

(22) Filed: Dec. 9, 2005

Related U.S. Application Data
(63) Continuation of application No. PCT/US05/32630, filed on Sep. 14, 2005.
(60) Provisional application No. 60/610,156, filed on Sep. 14, 2004.

(51) Int. Cl. G01N 11/00

(52) U.S. Cl. 73/53.01

(57) ABSTRACT

In one embodiment, an in-process mass spectrometry (IPMS) system is provided that includes: a plurality of sample mix modules, each sample mix module operable to select an extracted sample from a corresponding plurality of sample extraction modules, wherein each sample extraction module is operable to extract sample from a corresponding process solution bath having at least one analyte, each sample mix module being further operable to mix the selected extracted sample with a spike solution to form a mixture; a mass spectrometer operable to process the mixture from each sample mix module to form a mass spectral response having a spike response and an analyte response; and at least one processor operable to control the pluralities of sample extraction modules, the pluralities of sample mix modules, and the mass spectrometer such that the sample extraction modules automatically extract samples, the plurality of sample mix modules automatically mix the selected extracted samples with spike solution, and the mass spectrometer automatically process the mixtures, the at least one processor being further operable to characterize the concentration of the at least one analyte based upon a ratio measurement derived from the spike response and the analyte response.

### RELATED APPLICATION

This application is a Continuation of International Application No. PCT/US2005/032630, filed Sep. 14, 2005, which in turn claims the benefit of U.S. Provisional Application No. 60/610,156, filed Sep. 14, 2004, the contents of both of which are incorporated by reference in their entirety.

### BACKGROUND OF THE INVENTION

The present invention relates to mass spectrometry, and more particularly to in-process mass spectrometry (IPMS) with sample multiplexing.

Mass spectrometry is generally the technique of choice for measurement of parts per billion (ppb) and sub-ppb levels such as parts per trillion (ppt) of elements and compounds in solutions. For example, the present assignee, Metara, Inc., has developed an automated in-process mass spectrometry (IPMS) system that for the first time allows users such as semiconductor manufacturers to detect, identify, and quantify the chemistry of wet process baths and cleaning solutions. Unlike traditional mass spectrometry instruments, the IPMS technique is automated and requires no human intervention. In contrast, the use of traditional mass spectrometers such as an inductively-coupled-plasma mass spectrometer (ICP-MS) requires hands-on attention from highly-trained personnel.

The use of conventional mass spectrometry is typically “open loop” in that a calibration curve is first established by the users. In general, progressively concentrated (or diluted) solutions of the analyte of interest are processed through the mass spectrometer (MS) instrument and the results recorded. For example, a 10 ppm solution may be processed, then a 20 ppm solution, and so on. Having established this calibration curve, a user may then analyze the solution of interest. By comparing response from the analyte to the calibration curve, a user may determine the amount of the analyte. If, for example, the response lies halfway between the 10 ppm and 20 ppm calibration curve recordings, a quantification of 15 ppm may be assumed.

But mass spectrometers are prone to response shifts over time. Moreover, there may be response shifts caused by the difference between the matrices of the calibration standard and the sample. For example, if an acidic matrix shifts in composition, the calibration process must be repeated. These response shifts may be rapid, requiring frequent re-calibrations by experienced technicians. Thus, traditional mass spectrometry analysis was inappropriate for application requiring continuous and unattended operation such as in semiconductor manufacture. In contrast to traditional techniques, however, IPMS instruments are “closed loop” and thus do not suffer from response shifts.

In an IPMS instrument, a processor controls an automatic sampling of the solution of interest, spiking the sample with a calibration standard, ionizing the spiked sample, processing the ionized spiked sample through the mass spectrometer to produce a ratio response, and analyzing the ratio response to determine the amount of one or more analytes in the sample. Unlike prior art open loop techniques, response drifts are not a problem—the drift affects the spike and sample in the same fashion and is thus cancelled in the ratio response. The addition of a known amount of spike to a sample “closes the loop” and provides accurate results. Thus, automated operation may be implemented without the necessity of manual intervention or recalibration. In addition, stable and reliable operation is assured by, in an embodiment, the use of atmospheric pressure ionization (API) such as electrospray to ionize the spiked sample. Moreover, the use of API preserves molecular species. Furthermore, the IPMS technique is applicable to the analysis of analytes in either trace or bulk concentrations.

Although the IPMS technique represents a significant advance in the art, it faces challenges as well. For example, in a semiconductor manufacturing application, a user may desire to monitor baths of widely different chemistries. For example, an SC2 bath is acidic whereas an ammonium hydroxide bath is basic. Thus, IPMS systems have been developed having separate sample spiking paths. Each separate path may be referred to as a “channel.” For example, one channel may be dedicated to the spiking of SC1 (Standard Cleaning Solution 1) and another channel may be dedicated to the spiking of SC2 (Standard Cleaning Solution 2). Other channels may be dedicated to the spiking of UPW (Ultra Pure Water), dilute HF, and so on. However, each channel may need to monitor a plurality of sampling points. Because IPMS systems are complex and thus somewhat costly, forcing a user to purchase a plurality of IPMS systems to monitor the same types of baths can be quite expensive. Accordingly, there is a need in the art to provide improved IPMS systems having a plurality of channels, wherein each channel is configured to monitor multiple baths of the same or similar chemistry.

### SUMMARY

This section summarizes some features of the invention. Other features are described in the subsequent sections. In accordance with an aspect of the invention, an in-process mass spectrometry (IPMS) system is provided that includes: a plurality of sample mix modules, each sample mix module operable to select an extracted sample from a corresponding plurality of sample extraction modules, wherein each sample extraction module is operable to extract sample from a corresponding process solution bath having at least one analyte, each sample mix module being further operable to mix the selected extracted sample with a spike solution to form a mixture; a mass spectrometer operable to process the mixture from each sample mix module to form a mass spectral response having a spike response and an analyte response; and at least one processor operable to control the pluralities of sample extraction modules, the pluralities of sample mix modules, and the mass spectrometer such that the sample extraction modules automatically extract samples, the plurality of sample mix modules automatically mix the selected extracted samples with spike solution, and the mass spectrometer automatically process the mixtures, the at least one processor being further operable to characterize the concentration of the at least one analyte based upon a ratio measurement derived from the spike response and the analyte response.

In accordance with another aspect of the invention, a method is provided for extracting samples from a plurality of process solution baths, each process solution bath containing at least one analyte. The method includes the acts of selecting one of the process solution baths; drawing a sample using a vacuum source from the selected one of the process solution baths into a first reservoir, the first reservoir thereby containing an extracted sample; creating a pressure difference between the first reservoir and a second reservoir to expel the extracted sample through a length of tubing into the second reservoir; withdrawing an known volume of the extracted sample from the second reservoir and spiking it with a known volume of spike solution to form a mixture; processing the mixture through a mass spectrometer to form an analyte response and a spike response; and calculating a concentration of the at least one analyte using a ratio measurement derived from the analyte response and the spike response.

In accordance with another aspect of the invention, a mass spectrometry system is provided that includes: a plurality of sample mix modules; a plurality of sets of extraction modules, each set corresponding uniquely to a sample mix module, each extraction module operable to extract a sample from a corresponding process solution, wherein each sample mix module is operable to select from the corresponding set of extraction module and to receive the extracted sample from the selected extraction module, each sample mix module operable to mix the received extracted sample with a spike solution to produce a mixture; and a mass spectrometer operable to analyze the mixture from each of the sample mix modules.

The invention is not limited to the features and advantages described above. Other features are described below. The invention is defined by the appended claims.

### BRIEF DESCRIPTION OF THE DRAWINGS

FIG. 1 is a block diagram of an IPMS system according to an embodiment of the invention.

FIG. 2 is an illustration of a sample extraction module according to an embodiment of the invention.

FIG. 3. is an illustration of a sample mix module according to an embodiment of the invention.

FIG. 4. is an illustration of a mass spectrometry delivery module according to an embodiment of the invention.

### DETAILED DESCRIPTION

Reference will now be made in detail to one or more embodiments of the invention. While the invention will be described with respect to these embodiments, it should be understood that the invention is not limited to any particular embodiment. On the contrary, the invention includes alternatives, modifications, and equivalents as may come within the spirit and scope of the appended claims. Furthermore, in the following description, numerous specific details are set forth to provide a thorough understanding of the invention. The invention may be practiced without some or all of these specific details. In other instances, well-known structures and principles of operation have not been described in detail to avoid obscuring the invention.

One embodiment of the present invention will now be described in detail. This embodiment analyzes solutions often used in the semiconductor industry for electroplating, etching, depositions, wafer cleaning, and possibly other applications. It will be appreciated, however, that this embodiment is merely exemplary such that the invention is not limited to the analysis of semiconductor processing solutions.

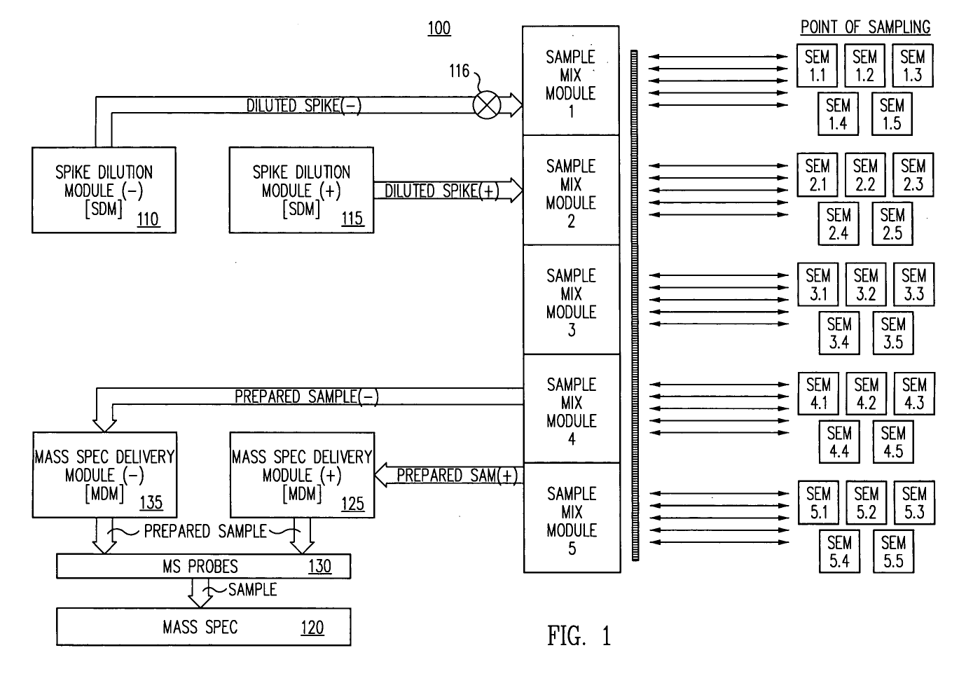

Turning now to FIG. 1, an IPMS system 100 is illustrated having a plurality of sample mix modules 1 through 5. Each sample mix module is configured to mix an extracted sample solution with a spike solution. As discussed earlier, because semiconductor processing solutions have such widely different chemistries, each module may be thought of as a “channel” dedicated to the analysis of a particular chemistry. For example, sample mix module 1 may be dedicated to the spiking of extracted SC2 samples. Similarly, sample mix module 2 may be dedicated to the spiking of extracted ammonium hydroxide solution, and so on. Although each sample mix module may be dedicated to the processing of a particular solution, a semiconductor manufacturing facility may have multiple baths or sampling points for the same processing solution. Thus, each sample mix module acts a multiplexer (MUX) to select sample from a plurality of sample extraction modules. For example, sample mix module 1 may spike a sample extracted by any one of five sample extraction modules 1.1 through 1.5. It will be appreciated, however, that the number of sample extraction modules (SEMs) connected to a given sample mix module may be greater or less than five. The remaining channels are similar. For example, sample extraction module 2 connects to SEMs 2.1 through 2.5. Similarly, sample extraction module 3 connects to SEMs 3.1 through 3.5, and so on.

Because a ratio measurement is most accurate when the concentrations of analyte and spike are approximately equal, if the analyte is present in trace concentrations such as a few ppt, then the spike concentration should also be a few ppt. In general, the spike for a given analyte may be the same as the analyte except for having an altered isotopic ratio such that the ratio measurement becomes an implementation of the well-known isotope dilution mass spectrometry (IDMS) technique. Alternatively, the spike may be a chemical homologue of the analyte. For example, the present assignee has developed the use of a bis(3-sulfoethyl)disulfide (SES) spike for a bis(3-sulfopropyl)disulfide (SPS) analyte. SES is sufficiently similar to SPS in molecular weight and chemical behavior such that it acts a chemical homologue to SPS upon ionization and characterization within a mass spectrometer 120 in IPMS system 100. Regardless of whether an IDMS or chemical homologue spike is used, it should have a concentration of a few ppt if the corresponding analyte concentration is also a few ppt. However, the storage of spike at such trace concentrations is problematic. For example, the spike may plate out on the container walls or otherwise be lost. Thus, it is preferable to store the spike in a more concentrated form so that it may be diluted before being mixed with a sample in one of the sample mix modules. The types of analytes (and thus spikes) being analyzed will typically be different depending upon whether mass spectrometer 120 is analyzing the masses of positively or negatively charged ions. In general, the analysis of positively charged ions will be denoted by the positive mode “(+)” designation whereas the analysis of negatively charged ions will be denoted by the negative mode “(−)” designation. Thus, a spike dilution module (−) 110 is specialized for the dilution of negative mode spikes with a diluent source such as UPW whereas a spike dilution module (+) 115 is specialized for the dilution of positive mode spikes. Each spike dilution module may be implemented using a plurality of pumps (such as syringe pumps) and mixers as discussed, for example, in U.S. Ser. No. 10/086,025. The diluted spike from each spike dilution module may be directed to a selected sample mix module through a selection valve such as a selection valve 116 for the output of spike dilution module (−) 110. For illustration clarity, the corresponding selection valve for module 115 is not shown.

Each sample mix module may thus have a separate mixer dedicated to the mixing of sample with positive mode spike to produce a positive mode mixed sample (+). A mass spectrometer delivery module 125 receives the positive mode mixed sample (+) and delivers it to mass spectrometer 120. Mass spectrometer 120 may comprise a time of flight (TOF) electrospray mass spectrometer. Thus, mass spectrometer delivery module (+) 125 provides the positive mode mixed sample (+) to a selected one of a plurality of electrospray probes 130. However, it will be appreciated that other types of mass spectrometers may be implemented in the present invention such as inductively-coupled mass spectrometers. A mass spectrometer delivery module (−) 135 functions analogously to module 125 for the negative mode mixed sample (−).

The analytes being characterized in each process solution may be the same or may be unique to each solution. If IPMS system 100 were to spike for only one analyte during any given measurement cycle, the amount of time necessary to determine the concentrations of all the analytes of interest across the plurality of process solutions could become prohibitive. Thus, an IPMS system may be configured to spike each sample simultaneously for a plurality of analytes. The diluted spike solution added to the sample within each sample mix module may thus be a mixture of multiple spikes.

Given these plurality of spikes and analytes that may be present in the ionized mixture being analyzed by mass spectrometer 120 in IPMS system 100, a variety of mass spectrometer tunings may be used. For example, various settings such as capillary voltages, skimmer voltages, pulser voltages, and detector voltage levels comprise a mass spectrometer tuning. Each tuning is used to characterize a certain mass range. For example, one tuning may be used to characterize analytes of relatively low molecular weight whereas another tuning may be used to characterize analytes of higher molecular weight. The range of masses observable for a given tuning may be denoted as a mass window. The mass windows may be identified by an element within the window. For each mixed sample being processed by mass spectrometer 120, a plurality of mass windows will typically be analyzed. As disclosed in U.S. Provisional Application No. 60/711,083, filed Aug. 23, 2005, the contents of which are hereby incorporated by reference, the one or more processors (not illustrated) that control IPMS system 100 may be configured with a “data analysis engine” (DAE). The DAE uses the identity of the process solution being sampled and the mass spectrometer tunings to identify peaks of interest in the resulting mass spectrums from mass spectrometer 120. The DAE performs a ratio measurement using the identified peaks to calculate the concentrations of the analytes.

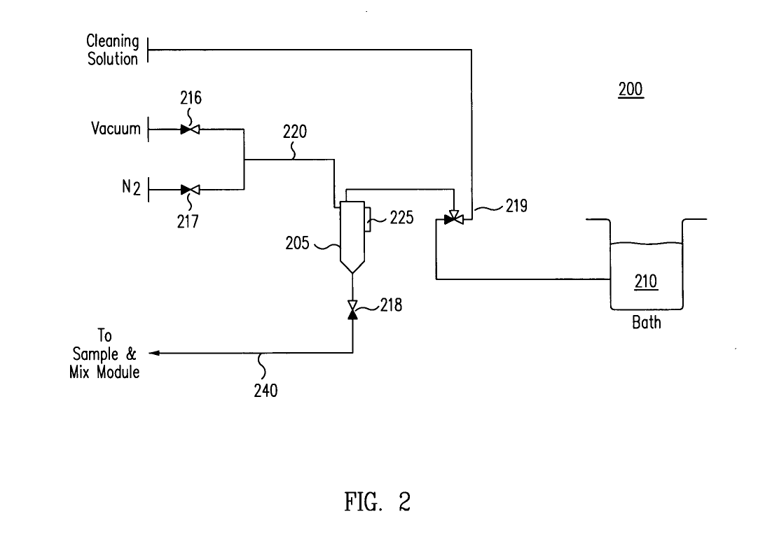

Should IPMS system 100 be implemented in a semiconductor manufacturing facility, many or all of the sampling points for the sample extraction modules may be located in semiconductor clean rooms. The location of a mass spectrometer within a controlled environment such as a clean room may be problematic to the user. It is thus desirable to physically isolate the sample extraction modules from the remaining components of IPMS 100. However, suppose each sample extraction module (SEM) couples to its corresponding sample mix module through a conduit or tubing having a length of 50 feet or greater. The volume of extracted sample filling such a length of tubing will depend upon its width. For example, a 50 foot tubing having an internal diameter of 1/16 of an inch holds over 30 milliliters of solution. To ensure fresh sample, each extracted sample delivered to the corresponding sample mix module would have to be greater than 30 milliliters. Alternatively, more appropriate sample sizes (such as two milliliters) could be withdrawn. However, that leaves a considerable volume within the tubing that will not only become stale but also hinder real-time monitoring of bath conditions. The volume of the tubing will increase as the desired physical separation between each SEM and corresponding sample mix module is increased, thereby exacerbating these problems. Turning now to FIG. 2, a sample extraction module (SEM) 200 is illustrated that avoids excessive extraction of sample volume and enables real-time monitoring of bath conditions. SEM 200 represents an exemplary implementation of SEM 1.1 through 5.5 of FIG. 1. A sealed reservoir 205 connects to a process solution bath 210. Because reservoir 205 is sealed, if vacuum is applied through actuation of a valve 216 on a tubing 220 connected to an upper portion of reservoir 205, sample will flow from bath 210 and into reservoir 205. A sensor 225 indicates that reservoir 205 has filled with a desired volume of sample at which point the vacuum may be switched off using valve 217 to prevent further withdrawal of sample into reservoir 205. In addition, valve 219 may isolate bath 210 at this time. In one embodiment, vacuum to reservoir 205 may be switched off after 2 milliliters of sample have been withdrawn into reservoir 205. At this point the extracted sample is ready for delivery to the corresponding sample mix module. Advantageously, an inert compressed gas is used to expel the contents of reservoir 205 through a tubing 240 that couples SEM 200 to the corresponding sample mix module. For example, a valve 217 may be actuated to couple a source of compressed N₂ gas to tubing 220. The compressed N₂ gas may thus force the contents of reservoir 205 into tubing 240 if an exit valve 218 is actuated. As discussed previously, to provide the desired degree of physical separation between SEM 200 and the remaining components of IPMS system 100, tubing 240 may be relatively long such as 10 feet, fifty feet, or greater than 100 feet. But because of the compressed gas propulsion, the extracted sample from SEM 200 travels through tubing 240 as a contiguous slug or volume, thereby avoiding having any sample becoming stale in tubing 240. To avoid nebulizing the slug of extracted sample as it travels through conduit 240, the compressed N₂ gas source is preferably pressurized to around seven to nine PSI. Having delivered its sample, reservoir 205 may be flushed with a cleaning solution such as UPW through actuation of a three-way valve 219. It will be appreciated that at least one isolation valve (not illustrated) may be provided between the cleaning solution source and three-way valve 219. Referring back to FIG. 1, the vacuum source, compressed gas source, and cleaning solution may be distributed to each SEM module through corresponding tubing and valving as discussed with regard to SEM 200.

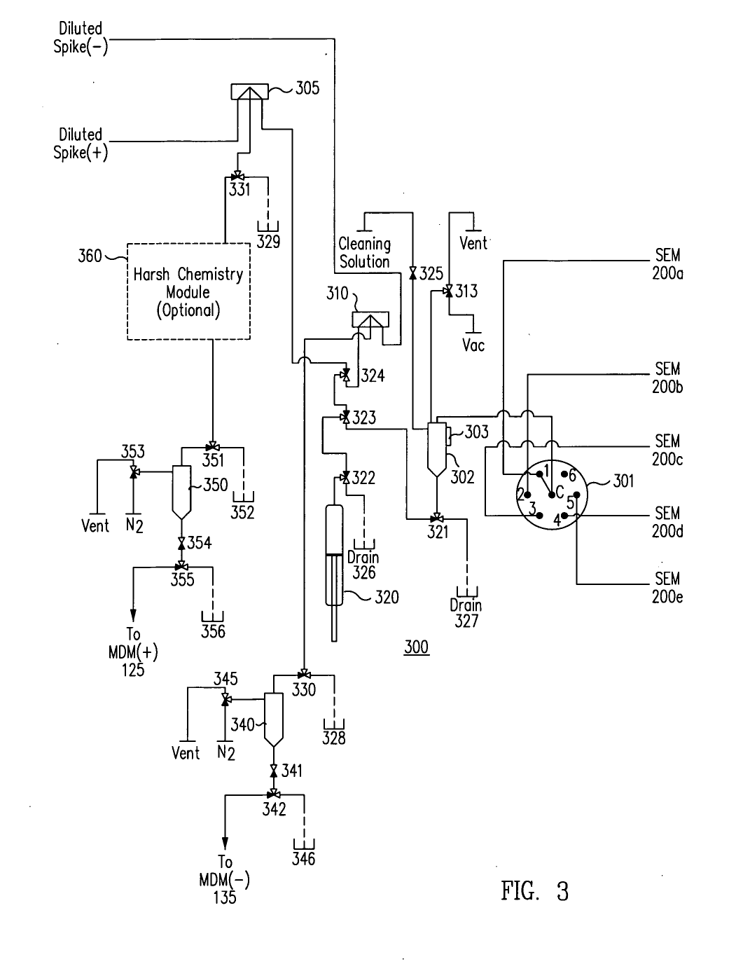

The extracted sample from a given SEM will thus arrive at the corresponding sample mix module as propelled by compressed gas. As discussed above, each sample mix module may be through of as a “channel” dedicated to a particular bath type or family of bath types having sufficiently similar chemistry. Thus, the corresponding sample mix module depends upon which channel a particular SEM is assigned or dedicated to. For example, as seen in FIG. 1, SEMs 1.1 through 1.5 provide their extracted sample to the same channel as implemented in sample mix module 1. An exemplary sample mix module 300 is illustrated in FIG. 3. Sample mix module (SMM) 300 represents any one of sample mix modules 1 through 5 of FIG. 1. SMM 300 can receive an extracted sample from a selected one of SEM 200a through 200e by appropriate actuation of a selection valve 301. Because the extracted sample will be arriving as a gas-propelled sample, it is preferable to have a reservoir 302 to receive the extracted sample from selection valve 301. To assist the propulsion of sample into reservoir 301, reservoir 302 may also be coupled to a vacuum source through actuation of a valve such a three-way valve 310 that also permits reservoir 302 to couple to a vent. As sample is being propelled to reservoir 302, valve 310 would be actuated to apply a vacuum to reservoir 302. In that regard, rather than apply vacuum to reservoir 302 while pressurizing reservoir 205, sample could be propelled to reservoir 302 solely by applying vacuum to reservoir 302. It will thus be appreciated that sample may be propelled by a pressure difference between reservoirs 205 and 302 regardless of whether that pressure difference is created through application of pressure to reservoir 205 and/or vacuum to reservoir 302. Reservoir 302 is analogous to reservoir 205 in that it may also include a sensor 303 that indicates when reservoir has received sufficient amount of extracted sample. Selection valve 301 may be cleansed by flowing cleaning solution into an unused port such as port 6 into a drain such as drain 327.

The ratio measurement used in IPMS system 100 depends upon spiking a known volume of sample with a known volume of spike at a known concentration. Thus, it would not be desirable to propel the contents of reservoir 301 with compressed gas into a mixer to mix with spike because the volume of sample would not be known with precision or accuracy. Instead a pump such as a syringe pump 320 controlled by a precision stepper motor (not illustrated) may be used to extract a known volume of sample from reservoir 301 through appropriate actuation of valves such as three-way valves 321, 322, and 323. Having extracted the desired and known volume of sample from reservoir 321, syringe pump 320 may then pump the sample into a mixer so that it may be mixed with spike. Depending upon whether an extracted sample is to be processed in positive or negative mode, a three-way valve 324 directs sample from syringe pump 320 into either a positive mode mixer 305 or a negative mode mixer 310. Referring back to FIG. 1, negative mode mixer 310 receives its diluted spike (−) from spike dilution module (−) 110 as directed by selection valve 116. Positive mode mixer 305 receives its diluted spike (+) in analogous fashion.

It will be appreciated, however, that IPMS system 100 may be utilized in applications that do not require spike dilution in that the concentration of the corresponding analyte(s) is sufficiently concentrated such that the corresponding concentration of the spike(s) is stable in solution. In that regard, the inclusion of spike dilution modules is optional in IPMS system 100. In such embodiments, SMM 300 would receive its spike from a positive mode and negative mode spike delivery module (not illustrated). Each such delivery module includes a pump such as a syringe pump that may withdraw a known volume of spike from a spike source and pump it into a selected one of the mixers analogously as discussed with regard to spike dilutions modules 110 and 115.

Preferably each mixer is configured as a “mixer-tee” such that it introduces substantial direction change in the flow of diluted spike and sample to thereby induce turbulent mixing. In this fashion, sufficient equilibration of the mixed sample and spike is achieved. After sample has been provided to a selected one of mixers 305 and 310, SMM 300 may purge and cleanse various components. For example, a cleaning solution source may pump a cleaning solution such as diluted nitric acid into reservoir 301 through a valve 325. Valves 321 through 324 and associated tubing as well as syringe pump 320 may then be cleansed and the resulting cleaning solution rinse dumped into drains 326 and 327. Syringe pump 320 may also pump cleaning solution into mixers 305 and 310 into drains 328 and 329 through appropriate actuation of three-way valves 330 and 331.

Preferably, the mixed sample and spike from each mixer may be received in additional reservoirs. For example, an output from mixer 310 may flow through valve 330 into a reservoir 340. From reservoir 340, the mixed sample and spike may flow to mass spectrometer delivery module (MDM) (−) 135 through valves 341 and 342. Because mixer 310 has already mixed known volumes of diluted spike (−) and extracted sample, the contents of reservoir 340 may be conveniently propelled to MDM (−) 135 using an inert compressed gas such as N₂ analogously as discussed with regard to reservoir 205. For example, a source of compressed N₂ may couple to reservoir 340 through a three-way valve 345 that may also be actuated to couple reservoir 340 to a vent. Reservoir 340 may be flushed during a cleaning cycle into a drain 346. It will be appreciated that such a mode of fluid transport, i.e., creating a pressure difference between a first reservoir and a second reservoir to propel the fluid contents of the first reservoir into the second reservoir through a connecting tubing may be advantageously implemented in other sorts of chemical analysis systems besides the IPMS system disclosed herein.

The mixed sample and spike from mixer 305 may be received in a reservoir 350 analogously as discussed with respect to reservoir 340. Thus, the output from mixer 305 may flow through a three-way valve 351 into reservoir 350. During a cleaning cycle, however, the output from mixer 305 may flow through valve 351 into a drain. The contents of reservoir 350 may be propelled into MDM (+) 125 using compressed N₂ after appropriate actuation of valves 353, 354, and 355. During a cleaning cycle, the contents of reservoir 350 may flow into a drain 356.

It will be appreciated that other processing acts may occur within SMM 300 besides the mixing of diluted spike and sample. One such processing act is described in U.S. Ser. No. 11/178,857, filed Jul. 11, 2005, the contents of which are incorporated by reference herein. A module which implements the processing disclosed in U.S. Ser. No. 11/178,857 (the '857 application) may be referred to as a “harsh chemistry module” in that it removes harshly acidic matrices that would otherwise require dilution or analogous conventional acts to remove the acidic matrices. Unlike these conventional acts, the harsh chemistry module preserves the ability to characterize analytes such as trace metals and cations despite the removal of the harshly acidic matrix. As disclosed in the '857 application, a column packed with weak anion exchange resin may be activated with a weakly acidic metal complexing reagent. For example, a weak anion exchange resin such as one implemented using tertiary amines may be activated with acetic acid. In general, a “weakly” acidic metal complexing reagent refers to a reagent having a pKa whose relationship to the pKa for the functional groups in the weak anion exchange resin is such that a substantial portion of the functional groups are left un-protonated after exposure to the weakly acidic metal complexing reagent. As seen in FIG. 3, a harsh chemistry module 360 may be used to treat the mixed sample and spike provided by mixer 305.

With respect to the analysis or detection of metals in acidic matrices, suitable organic and inorganic weakly acidic metal complexing reagents to activate the resin include formic acid, acetic acid, oxalic acid, glycolic acid, ethylenediaminetetraacetic acid (EDTA), nitrotriacetic acid (NTA), diethylenetriaminepentaacetic acid (DTPA), ethylenediamine (EDA), glycine, and iminodiacetic acid (IDA). For example, acetic acid may be used to activate a column packed with the weak anion exchange resin. Because of the weak acidity of the metal complexing reagent, it is believed that only a relatively small percentage of the functional groups in the resin will be protonated. These positively-charged functional groups (such as positively-charged tertiary amines) may then adsorb or bind with the metal complexing anion formed after donation of the proton by the weakly acidic metal complexing reagent.

Note that one could reduce undesirable proton levels in harshly acidic matrices by simply eluting the acidic solutions through a column packed with a weak anion exchange resin. But there are problems such as metal retention and trapping, precipitation, and oxidation, which cause undesirable memory effects and other errors in the detection and quantification of the trace metal concentrations. If an anion exchange resin were simply used to eliminate an acidic matrix without any other processing, these trace metal analysis problems would remain. However, trace metal analysis is enabled by the initial activation of the resin by the weakly acidic metal complexing reagent. It is believed that this treatment leaves a relatively small percentage of the functional groups in the resin already protonated and associated with the resulting metal complexing anion. For example, with respect to the treatment of samples of SC2 solution, it is believed that this metal complexing anion will have a weaker binding affinity to the protonated functional group than will the chloride anion in the SC2 solution. Thus, the chloride anion exchanges with the metal complexing anion. The majority of the metal complexing anions will thus combine with the remaining protons in the SC2 solution to form the non-ionized metal complexing reagent because the bulk of a weak acid in solution does not disassociate into protons and anions. Those metal complexing reagent anions that are disassociated are then free to complex with and stabilize the metals. Advantageously, the complexing of the metal complexing anion such as acetate with metals is a soft bond such that it is easily disassociated even in a relatively gentle ionization process such as electrospray ionization. Moreover, because the metal complexing reagent is weakly acidic, the eluent from the weak anion exchange column has a pH that is kept substantially neutral, for example a pH of 6.7.

It is further believed that the weakly acidic metal complexing reagent provides a further benefit besides complexing the metals in the treated solution. For example, a weak anion exchange resin will typically have a certain concentration of hydroxide ions distributed through the resin. For example, although a tertiary amine is only weakly basic, it is basic nonetheless and thus will have a tendency to ionize with a water molecule such that the tertiary amine becomes protonated and a hydroxide anion is produced. However, activation of the weak anion exchange resin with the weakly acidic metal complexing reagent eliminates these hydroxide ions from the resin prior to treating the acidic matrix. In contrast, consider what could happen should the resin not be activated by the weakly acidic metal complexing reagent. As the acidic matrix flows into a column of such un-activated resin, any hydroxide ions near the entry port of the column will be eliminated by the acid matrix. However, the matrix continues to be neutralized as it flows through the column such that the solution near the exit port of the column will have little acidity. Thus, hydroxide ions could still be present near the exit port within the resin. These hydroxide ions would thus be available to react with metals, thereby causing precipitates and hampering the ability to detect and/or characterize trace metals.

Having treated the harshly acidic solution, the weak anion exchange resin is easily regenerated with an appropriate strong base such as ammonium hydroxide, sodium hydroxide, or methylamine. In the regeneration of an anion exchange resin, the protonated basic sites are returned to their neutral basic states. For example, a protonated tertiary amine would be reduced to a neutral state upon regeneration. The regenerated column may then be re-activated by treatment with the weakly acidic metal complexing reagent to be ready to neutralize another sample of acidic matrix while stabilizing the trace metals.

As known in the art, the polymer backbone of a weak anion exchange resin may be based on synthetic polymers such as styrene-divinylbenzene copolymer, acrylic, polysaccharides, or many other suitable polymers. A weak anion exchange resin is generally supplied in the form of beads, which may either be dense (gel resins) or porous (macroporous resins). The technique disclosed in the '857 application is relatively insensitive to the particular form of the beads.

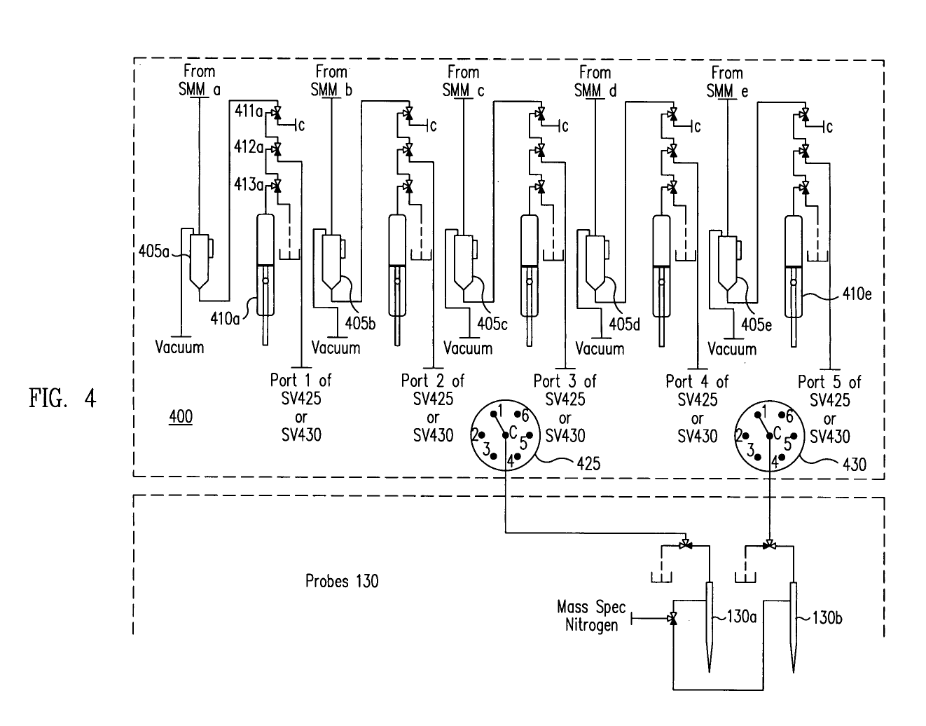

Regardless of whether additional modules such as harsh chemistry module 360 are included within SMM 300, a spiked sample is provided to a selected one of MDM (+) 125 and MDM (−) 135. Turning now to FIG. 4, an exemplary MDM 400 is illustrated. Both MDM (+) 125 and MDM (−) 135 may be implemented as shown for MDM 400. MDM 400 receives spiked samples from each channel in IPMS system 100. For example, if there are five channels (and hence five corresponding SMMs designated as SMMa through SMMe), MDM 400 would receive spiked samples from these five channels. Within MDM 400, reservoirs may be provided to receive spiked sample from SMMa though SMMe. For example, a reservoir 405a may receive spiked sample from SMMa. As discussed above, this spiked sample may be propelled into reservoir 405a by applying pressurized gas to the corresponding reservoir in SMMa and/or applying vacuum to reservoir 405a. Similarly, a reservoir 405b may receive spiked sample from SMMb, and so on. A vacuum source may be connected to each reservoir 405a through 405e to assist in receiving the corresponding spiked sample. A pump such as a syringe pump corresponds to each reservoir and acts to pump a known volume of sample from the corresponding reservoir into a probe 130. For example, with regard to reservoir 405a, a syringe pump 410a withdraws spiked sample from reservoir 405a through valves 411a, 412a, and 413a. Syringe pump 410a may then pump its contents through valves 413a and 412a into a probe 130.

Because the accuracy and performance of IPMS system 100 is enhanced if probes 130 are conditioned and used for similar chemistries, samples from like chemistries should be directed to the same probes. For example, probes 130a and 130b may be so dedicated such that one probe is used for acidic solutions and another is used for basic solutions. In this fashion, precipitation of salts from acid-base reactions that could clog the probes is minimized. Thus, MDM 400 may include a selection valve (SV) 425 providing an output to probe 130a and a selection valve (SV) 430 providing an output to probe 130b. Each selection valve may select for particular ones of syringe pumps 405a through 405e to direct the appropriate spiked sample to the appropriate probe. Rather than use just two probes 130a and 130b, a greater plurality of probes may be utilized as disclosed in PCT/US05/05803, filed Feb. 23, 2005, entitled “Multiple Electrospray Needle Interface for Mass Spectrometry,” the contents of which are incorporated by reference herein.

The above-described embodiments of the present invention are merely meant to be illustrative and not limiting. For example, the number of sample extraction modules may be varied. Moreover, the mass spectrometer need not utilize atmospheric pressure ionization such as electrospray but instead may utilize other ionization sources such as inductively-coupled plasma ionization. Thus, the scope of the present invention is defined only by the following claims.

We claim:

1. An in-process mass spectrometry (IPMS) system, comprising:
a plurality of sample mix modules, each sample mix module operable to select an extracted sample from a corresponding plurality of sample extraction modules, wherein each sample extraction module is operable to extract sample from a corresponding process solution bath having at least one analyte, each sample mix module being further operable to mix the selected extracted sample with a spike solution to form a mixture;
a mass spectrometer operable to process the mixture from each sample mix module to form a mass spectral response having a spike response and an analyte response; and
at least one processor operable to control the pluralities of sample extraction modules, the pluralities of sample mix modules, and the mass spectrometer such that the sample extraction modules automatically extract samples, the plurality of sample mix modules automatically mix the selected extracted samples with spike solution, and the mass spectrometer automatically process the mixtures, the at least one processor being further operable to characterize the concentration of the at least one analyte based upon a ratio measurement derived from the spike response and the analyte response.

2. The IPMS system of claim 1, wherein each sample extraction module comprises:
a reservoir connected to the corresponding process solution bath; and
a source of vacuum connected through a first valve to the reservoir, wherein if the valve is opened, vacuum from the source draws sample from the corresponding solution bath into the reservoir, and wherein the at least one processor controls whether the first valve.

3. The IPMS system of claim 2, wherein each sample extraction module further comprises:
a source of compressed gas connected through a second valve to the reservoir, the reservoir being connected to the corresponding sample mix module through a tubing, wherein if the second valve is closed and the reservoir contains extracted sample, the extracted sample is propelled by the compressed gas through the tubing to the corresponding sample mix module, and wherein the at least one processor controls the second valve.

4. The IPMS system of claim 3, wherein each sample mix module includes a selection valve connected to the tubing from each of the corresponding plurality of sample extraction modules to provide the selected extracted sample, the selection valve being controlled by the at least one processor.

5. A method of extracting samples from a plurality of process solution baths, each process solution bath containing at least one analyte, comprising:
selecting one of the process solution baths;
drawing a sample using a vacuum source from the selected one of the process solution baths into a first reservoir, the first reservoir thereby containing an extracted sample;
withdrawing an known volume of the extracted sample from the second reservoir and mixing it with a known volume of spike solution to form a mixture;
processing the mixture through a mass spectrometer to form an analyte response and a spike response; and
calculating a concentration of the at least one analyte using a ratio measurement derived from the analyte response and the spike response.

6. The method of claim 5, wherein the pressure difference is created by pressurizing the first reservoir with compressed gas.

7. The method of claim 5, wherein the pressure difference is created by applying a vacuum to the second reservoir.

8. The method of claim 5, wherein the length of tubing is at least ten feet.

9. The method of claim 5, wherein the length of tubing is at least fifty feet.

10. The method of claim 5, wherein the length of tubing is at least 100 feet.

11. The method of claim 5, wherein withdrawing the known volume of the extracted sample comprises pumping the known volume of the extracted sample from the second reservoir using a syringe pump.

12. The method of claim 5, wherein processing the mixture through the mass spectrometer includes ionizing the mixture using atmospheric pressure ionization.

13. The method of claim 10, wherein ionizing the mixture using atmospheric pressure ionization comprises ionizing the mixture using electrospray.

14. A mass spectrometry system, comprising:
a plurality of sample mix modules;
a plurality of sets of extraction modules, each set corresponding uniquely to a sample mix module, each extraction module operable to extract a sample from a corresponding process solution, wherein each sample mix module is operable to select from the corresponding set of extraction module and to receive the extracted sample from the selected extraction module, each sample mix module operable to mix the received extracted sample with a spike solution to produce a mixture; and
a mass spectrometer operable to analyze the mixture from each of the sample mix modules.

15. The mass spectrometry system of claim 14, wherein the mass spectrometer is configured to use atmospheric pressure ionization.

16. The mass spectrometry system of claim 15, wherein the mass spectrometer is an electrospray mass spectrometer.

17. The mass spectrometry system of claim 14, wherein the mass spectrometer is configured to use inductively-coupled plasma ionization.

18. A method, comprising:
extracting a sample solution;
performing a first processing act on the sample solution to form a processed sample solution;
receiving the processed sample solution in a first reservoir;
creating a pressure difference between the first reservoir and a second reservoir to expel the processed sample solution through a length of tubing into the second reservoir;
withdrawing the processed sample from the second reservoir; and
analyzing the concentration of at least one analyte in the withdrawn processed sample.

19. The method of claim 18, wherein the pressure difference is created by pressurizing the first reservoir with compressed gas.

20. The method of claim 18, wherein the pressure difference is created by applying a vacuum to the second reservoir.
